(19) United States
(12) Patent Application Publication
(10) Pub. No.: US 2026/0125592 A1
(43) Pub. Date: May 7, 2026

(54) LOST-CIRCULATION MATERIAL MADE FROM INORGANIC, RECYCLED ROOFING MATERIALS

(71) Applicant: Halliburton Energy Services, Inc., Houston, TX (US)

(72) Inventors: Ronnie Glen MORGAN, Duncan, OK (US); Paul J. JONES, Houston, TX (US)

(73) Assignee: Halliburton Energy Services, Inc., Houston, TX (US)

(21) Appl. No.: 18/934,804

(22) Filed: Nov. 1, 2024

(51) Int. Cl. C09K 8/03; C09K 8/40; C09K 8/42; C09K 8/60

(52) U.S. Cl. CPC C09K 8/032; C09K 8/40; C09K 8/42; C09K 8/60

(57) ABSTRACT

A method of treating a portion of a subterranean formation can include introducing a treatment fluid into the portion of the subterranean formation. The treatment fluid can be a drilling fluid, a spacer fluid, a cement composition, or a stimulation fluid. The treatment fluid can include a base fluid; and a lost-circulation material (LCM), wherein the LCM comprises a plurality of particles of inorganic components of roofing materials, wherein the plurality of particles has a particle size distribution (PSD), and wherein the d99 particle size is in a range of 25 to 35 times greater than the d10 particle size; and allowing the LCM to reduce loss of the base fluid into the subterranean formation. The particles of the LCM can include solid aggregates of a combination of different minerals. The PSD and concentration of the LCM can be selected to provide a targeted fluid loss control.

### TECHNICAL FIELD

A treatment fluid containing a lost-circulation material of inorganic, recycled roofing materials can be used to reduce or prevent lost circulation into a subterranean formation.

### BRIEF DESCRIPTION OF THE FIGURES

The features and advantages of the embodiments will be more readily appreciated when considered in conjunction with the accompanying figures. The figures are not to be construed as limiting any of the embodiments.

FIG. 1 illustrates a system for preparation and delivery of a cement composition to a wellbore according to certain embodiments.

FIG. 2A illustrates surface equipment that may be used in placement of a cement composition into a wellbore.

FIG. 2B illustrates placement of a cement composition into an annulus of a wellbore.

### DETAILED DESCRIPTION

Oil and gas hydrocarbons are naturally occurring in some subterranean formations. In the oil and gas industry, a subterranean formation containing oil and/or gas is referred to as a reservoir. A reservoir can be located under land or offshore. Reservoirs are typically located in the range of a few hundred feet (shallow reservoirs) to a few tens of thousands of feet (ultra-deep reservoirs). To produce oil or gas, a wellbore is drilled into a reservoir or adjacent to a reservoir. The oil, gas, or water produced from a reservoir is called a reservoir fluid.

As used herein, a “fluid” is a substance having a continuous phase that can flow and conform to the outline of its container when the substance is tested at a temperature of 71° F. (22° C.) and a pressure of one atmosphere “atm” (0.1 megapascals “MPa”). A fluid can be a liquid or gas. A homogenous fluid has only one phase; whereas a heterogeneous fluid has more than one distinct phase. A colloid is an example of a heterogeneous fluid. A heterogeneous fluid can be a slurry, which includes a continuous liquid phase and undissolved solid particles as the dispersed phase; an emulsion, which includes a continuous liquid phase and at least one dispersed phase of immiscible liquid droplets; a foam, which includes a continuous liquid phase and a gas as the dispersed phase; or a mist, which includes a continuous gas phase and liquid droplets as the dispersed phase. As used herein, the term “base fluid” means the solvent of a solution or the continuous phase of a heterogeneous fluid and is the liquid that is in the greatest percentage by volume of a treatment fluid.

A well can include, without limitation, an oil, gas, or water production well, an injection well, or a geothermal well. As used herein, a “well” includes at least one wellbore. A wellbore can include vertical, inclined, and horizontal portions, and it can be straight, curved, or branched. As used herein, the term “wellbore” includes any cased, and any uncased, open-hole portion of the wellbore. A near-wellbore region is the subterranean material and rock of the subterranean formation surrounding the wellbore. As used herein, a “well” also includes the near-wellbore region. The near-wellbore region is generally considered to be the region within approximately 100 feet radially of the wellbore. As used herein, “into a subterranean formation” means and includes into any portion of the well, including into the wellbore, into the near-wellbore region via the wellbore, or into the subterranean formation via the wellbore.

A portion of a wellbore can be an open hole or cased hole. In an open-hole wellbore portion, a tubing string can be placed into the wellbore. The tubing string allows fluids to be introduced into or flowed from a remote portion of the wellbore. In a cased-hole wellbore portion, a casing is placed into the wellbore that can also contain a tubing string. A wellbore can contain an annulus. Examples of an annulus include but are not limited to the space between the wellbore and the outside of a tubing string in an open-hole wellbore; the space between the wellbore and the outside of a casing in a cased-hole wellbore; and the space between the inside of a casing and the outside of a tubing string in a cased-hole wellbore.

Oil or gas operations can be performed using a treatment fluid. The term “treatment fluid” refers to the specific composition of the fluid as it is being introduced into a well. The word “treatment” in the term “treatment fluid” does not necessarily imply any particular action by the fluid. Examples of treatment fluids include, but are not limited to, drilling fluids, spacer fluids, workover fluids, cement compositions, and stimulation fluids.

A wellbore is formed using a drill bit. A drill string can be used to aid the drill bit in drilling through the subterranean formation to form the wellbore. The drill string can include a drilling pipe. During drilling operations, a drilling fluid, sometimes referred to as a drilling mud, may be circulated downwardly through the drilling pipe, and back up the annulus between the wellbore and the outside of the drilling pipe. The drilling fluid is generally a slurry or an emulsion and contains a liquid continuous phase and soluble and/or insoluble additives. The drilling fluid performs various functions, such as cooling the drill bit, maintaining the targeted pressure in the well, and carrying drill cuttings upwardly through the annulus between the wellbore and the drilling pipe. Drilling fluid returned from the wellbore to the surface can be flowed through a shale shaker screen that has appropriately sized holes to retain the drill cuttings. The drilling fluid can then be re-introduced into the formation to continue with the drilling operation and continue being circulated down the drilling pipe, up through the annulus, through the shale shaker, and back into the drilling pipe.

After the wellbore is formed using the drilling fluid, a spacer fluid can be introduced into the wellbore. The spacer fluid can be pumped down through a string, such as a casing string or tubing string, and up into the annulus to the wellhead. The spacer fluid can flush residual drilling fluid that may remain in parts of the wellbore, the wellbore wall including the face of the subterranean formation, and the outside of tubing strings to help ensure better bonding of a cement composition to the interfaces. Additionally, the spacer fluid can serve as a means to physically separate the drilling fluid from the cement slurry.

During well completion, it is common to introduce a cement composition into a portion of an annulus in a wellbore. For example, in a cased-hole wellbore, a cement composition can be placed into and allowed to set in the annulus between the wellbore wall and the casing string or tubing string in order to stabilize and secure the string in the wellbore. By cementing the string in the wellbore, fluids are prevented from flowing into the annulus. Consequently, oil or gas can be produced in a controlled manner by directing the flow of oil or gas through the string and into the wellhead. In cementing operations, the cement composition is pumped down a string, out the bottom through equipment, and up or out into the annulus. In reverse cementing operations, the cement composition is pumped directly into the annulus, down to the bottom of the string, and partially up into the bottom of the string. In cementing operations, the top of the cement column may not be required to reach all the way to the top of the annulus close to the wellhead. In many instances, the top of the cement column may only need to reach 100 to 1,000 feet (30.5 to 304.8 meters) below the top of the annulus. Cement compositions can also be used in primary or secondary cementing operations, well-plugging, or gravel packing operations. As used herein, a “cement composition” or “cement slurry” is a mixture of at least cement and water as the base fluid. A cement composition can include additives. As used herein, the term “cement” means an initially dry substance that develops compressive strength or sets in the presence of water. A cement composition is generally a slurry in which the water is the base fluid or the continuous liquid phase of the slurry and the cement, and other undissolved solids, make up the dispersed phase of the slurry.

The wellbore wall and near-wellbore region of the subterranean formation can include permeable areas. Examples of permeable areas include cracks, natural fissures, fractures, vugs, interconnected pores, or induced fractures. Cracks, fissures, and fractures can generally be characterized as having a length greater than their diameter. Vugs and holes can be characterized as being any cavity having a variety of shapes and sizes. Porosity refers to the number of individual pores within an area of the subterranean formation. Permeability and all grammatical variations thereof, in this context, refers to the amount of interconnectivity between the individual pores that allows fluid to migrate or move between the interconnected pores. Permeable areas in the wall of the wellbore and near-wellbore region can vary and can have dimensions ranging from 0.1 micrometers and as large as 50 micrometers or larger. As used herein, a “permeable area” means any area where fluid can flow into the subterranean formation via a wellbore and can be caused by—without limitation—cracks, fissures, fractures, cavities, and interconnected pores.

A treatment fluid, such as a drilling fluid, spacer fluid. or cement composition, can encounter lost circulation. Lost circulation means that an undesirable portion of the base fluid flows into the subterranean formation instead of remaining in the wellbore, for example in the annulus, or returning to the surface. In an ideal drilling situation, the drilling fluid is pumped through a tubing string and returns to the surface via an annulus. The drilling fluid is generally pumped at or above the hydrostatic pressure of the subterranean formation. The pressure of the drilling fluid, being greater than or equal to the pressure of the formation, helps prevent the formation from caving into the newly formed wellbore, and it also helps prevent the oil or gas from prematurely entering the wellbore. In an ideal cementing operation, the cement composition is placed in the portion of the well to be cemented. The cement composition remains in the portion of the well until the composition eventually sets.

However, during lost circulation of a drilling fluid, some or all of the base fluid can enter the subterranean formation via any permeable areas. If a sufficient amount of the base fluid flows into the formation, then the total amount of pressure exerted on the formation by the fluid can decrease substantially. This decreased pressure can allow formation fluids, such as oil or gas, to prematurely enter the wellbore. The uncontrolled release of formation fluids is called a blowout. Another potential consequence of lost circulation for a drilling fluid is dry drilling. Dry drilling can damage the drill bit or the drill string, among other things.

Moreover, during lost circulation of a spacer fluid, the water of the base fluid can enter the subterranean formation. This can decrease the total volume of the spacer fluid such that the spacer fluid is not able to fully wipe the inside of the annulus to prepare surfaces for cementing. In this case, a larger total volume of spacer fluid may be required.

Moreover, during lost circulation of a cement composition, the water of the base fluid can enter the subterranean formation. Because the cement in the composition requires water to hydrate and is what ultimately allows the composition to set, the loss of water to the formation can cause severe adverse impacts to the cementing operation. For example, the cement composition may never set. If this occurs, a new cementing job will have to be performed. Removing the un-set cement composition and running a new cement job can cost time and money. Another issue of lost circulation in a cementing job is if the top of the cement column is predetermined to be, for example, 1,000 feet (ft.) (304.8 meters “m”) below the surface and enough of the base fluid is lost into the subterranean formation, then the total volume of cement becomes less than the amount needed for the top of the cement column to reach the intended height. Accordingly, the top of the cement column may wind up being located 1,500 or 2,000 ft. (457.2 or 609.6 m) below the surface instead of going all the way up to the 1,000 ft. (304.8 m) level.

In order to overcome the problems associated with lost circulation, lost-circulation materials (“LCM”), can be used. LCMs are generally insoluble and non-swellable particles. Generally, the LCM is included in the treatment fluid. As the treatment fluid is introduced into the subterranean formation, the LCM can eliminate or lessen the amount of the base fluid that is lost into the formation. The particles of the LCM can build upon each other and form a bridge over or within the permeable areas of the formation. For example, if a fracture is present in the formation, then the particles of the LCM can form a non-porous bridge or layer over the fracture entrance near the wall of the wellbore. The bridge or layer can eliminate or reduce the amount of liquid entering the formation via the fracture.

Other lost-circulation materials can be used that form a filtercake to reduce or stop fluid loss. A filtercake is the residue deposited on a permeable medium when a slurry, such as a drilling fluid, is forced against the medium under pressure. The filtrate is the liquid that passes through the medium, leaving the cake on the medium. In filtercake deposition, the slurry, that may include materials including water, a gelling agent, calcium carbonate, diatomaceous earth, lime, silica, clay, and/or polymers, is introduced into the open-hole wellbore. The fluid flows into a targeted portion of the well. The ingredients in the fluid form the filtercake. The filtercake can be used to bind fines, such as sand, together, and prevent fluid loss into the subterranean formation. Combinations of both insoluble LCM that pack into permeable areas and filtercake materials can also be used to reduce or prevent lost circulation.

There are several problems associated with current lost-circulation materials. First, the cost of lost-circulation materials continues to increase. Second, in most wellbores, a liner hanger is used to support or hang a liner from a casing. The space between the liner hanger and a casing shoe is called the liner hanger lap. Most LCMs have upper particles sizes that are too big to fit through liner hanger lap. This causes those particles to get clogged and blocks up the flow of the treatment fluid, which causes a pressure drop that requires higher pump pressures to be used. This alone can cause a host of issues. Therefore, there is a need for improved lost-circulation materials that are low-cost, effective, and can solve the problems associated with current LCM.

It has been discovered that inorganic, recycled roofing materials can be used as an LCM for wellbore treatment fluids. The materials can have a specific particle size distribution (PSD) that provides very effective reduction or prevention of loss of the base fluid into the subterranean formation.

The discussion of preferred embodiments regarding the treatment fluid or any ingredient in the treatment fluid, is intended to apply to the composition embodiments and the method embodiments. Any reference to the unit “gallons” means U.S. gallons.

The treatment fluid can be any fluid having a liquid continuous phase. The treatment fluid can be any fluid where lost circulation of the base fluid from a well into a subterranean formation might occur. The treatment fluid can be a drilling fluid, a spacer fluid, a cement composition, or a stimulation fluid. The treatment fluid can be a colloid. The treatment fluid can contain a base fluid. The base fluid can comprise water. The water can be selected from the group consisting of freshwater, brackish water, saltwater, and any combination thereof. The base fluid can also comprise an oil. As used herein, the term “oil” means a liquid comprising a hydrocarbon when measured at a temperature of 71° F. (21.7° C.) and a pressure of one atmosphere. Examples of oil include but are not limited to crude oil; a fractional distillate of crude oil; a fatty derivative of an acid, an ester, an ether, an alcohol, an amine, an amide, or an imide; a saturated hydrocarbon; an unsaturated hydrocarbon; a branched hydrocarbon; a cyclic hydrocarbon; and any combination thereof. Crude oil can be separated into fractional distillates based on the boiling point of the fractions in the crude oil. An example of a suitable fractional distillate of crude oil is diesel oil. The saturated hydrocarbon can be an alkane or paraffin. The paraffin can be an isoalkane (isoparaffin), a linear alkane (paraffin), or a cyclic alkane (cycloparaffin). The unsaturated hydrocarbon can be an alkene, alkyne, or aromatic. The alkene can be an isoalkene, linear alkene, or cyclic alkene. The linear alkene can be a linear alpha olefin or an internal olefin. The base fluid can also include dissolved substances or undissolved solids.

According to an embodiment, the treatment fluid is an emulsion or an invert emulsion further comprising a liquid dispersed phase. According to another embodiment, the treatment fluid is a slurry. The treatment fluid can include a dispersed phase. Preferably, the dispersed phase of the treatment fluid includes the lost-circulation material (“LCM”).

The treatment fluid also contains a lost-circulation material. The lost-circulation material comprises a plurality of particles of inorganic components of roofing materials. According to any of the embodiments, the roofing materials are recycled roofing materials. According to any of the embodiments, the LCM includes organic components of roofing materials in a concentration in a range of 0 to 10 weight percent (wt. %) of the total weight of the roofing materials. According to any of the embodiments, the LCM includes organic components of roofing materials in a concentration in a range of 0 to 1 weight percent (wt. %) of the total weight of the roofing materials. According to any of the embodiments, the concentration of organic components is 0 wt. % of the total weight of the roofing materials. Accordingly, the LCM can consist of or consist essentially of the inorganic components of roofing materials. Examples of organic components of roofing materials include without limitation, asphalt and felt backing. As used herein, the term “asphalt,” also known as bitumen, means a sticky, black, and highly viscous liquid or semi-solid that is present in most crude petroleum products and in some natural deposits. Asphalt can also be part of asphalt concrete. As used herein, the term “asphalt concrete” means a mixture of at least asphalt and mineral aggregate.

According to any of the embodiments, the treatment fluid further comprises other lost-circulation materials selected from the group consisting of polymers, calcium carbonate, diatomaceous earth, lime, silica, clay, vitrified shale, graphite, cedar fiber, shredded paper, cottonseed hulls, ground marble, ground nut shells, mica, cellophane, plastic flakes, graphite, and combinations thereof. The other LCM can form a filtercake on a wall of the wellbore. For example, the other LCM can include ingredients that chemically react to form a cementitious substance in the presence of water.

The plurality of particles of the LCM can be solid aggregates of minerals. Examples of minerals include without limitation calcite, dolomite, quartz, feldspar, mica, chlorite, and any combination in any proportion thereof. Calcite is a carbonate mineral and the most stable polymorph of calcium carbonate and is a component of limestone. Dolomite is an anhydrous carbonate mineral composed of calcium magnesium carbonate. Quartz is a crystalline mineral composed of silica. Feldspar is a group of rock-forming aluminum tectosilicate minerals, also containing other cations such as sodium, calcium, potassium, or barium. Mica is a group of silicate minerals and can include muscovite, which is a hydrated phyllosilicate mineral of aluminum and potassium. Chlorite is a group of phyllosilicate minerals and can include clinochlore, which is often found in metamorphic rocks.

The plurality of particles of the LCM has a particle size distribution (PSD). The particle size of the particles can be adjusted to meet the specific conditions of the well. As used herein, “particle size” can be determined using dry sieve analysis. Sieve analysis uses a column of sieves with wire mesh screens of graded mesh size. A representative weighed sample of particles is poured into the top sieve, which has the largest screen openings. Each lower sieve in the column has smaller openings than the one above. At the base is a pan, called the receiver. The column is typically placed in a mechanical shaker, which shakes the column, usually for a set period of time, to facilitate exposing all of the material to the screen openings so that particles small enough to fit through the holes can fall through to the next layer. After the shaking is complete, the material on each sieve is weighed. It is to be understood that as used herein, “particle” does not mean a specific geometric shape as particles can be spherically shaped, fiber-shaped, or other geometric shapes. As used herein, the term “fiber” means a solid that is characterized by having a high aspect ratio of length to diameter. For example, a fiber can have an aspect ratio of length to diameter greater than 1.2:1. Particle size can be determined by using sieves.

Particle-size distribution indicates the percentage of particles of a certain size (or in a certain size interval) in the whole. The PSD can also be a list of values or a mathematical function that defines the relative amount, typically by mass, of particles present according to size. For example, PSD can be determined after weighing particles in dry sieve analysis. To calculate the particle size distribution, the mass of the sample of each sieve is divided by the total mass to give a percentage retained on each sieve. The size of the average particle on each sieve is then analyzed to get a cut-off point or specific size range, which is then captured on a screen. The PSD can be quantified into size classes or fractions, such as d10, d50, and d90 by plotting the PSD on a graph. D10 means 10% of the particles have a particle size that is less than this value. D50 means 50% of the particles have a particle size less than (and 50% greater than) this value. The d50 value is also known as the median particle size. D90 means 90% of the particles have a particles size less than this value. Accordingly, d10 encompasses the smallest 10% of the particles by size, while d99 encompasses the top 1% of particles having the largest size.

The plurality of particles can have a particle size distribution of d99 in a range of 0.8 to 1.8 millimeter (mm), d90 in a range of 0.50 to 0.75 mm, d50 in a range of 0.15 to 0.35 mm, and d10 in a range of 0.02 to 0.05 mm. The particle size distribution can be selected such that all of the plurality of particles can fit through a liner hanger lap. Accordingly, all of the particles can have a particle size less than 2.3 mm. According to any of the embodiments, the d99 particle size is in a range of 25 to 40 times greater than, or 30 to 35 times greater than, the d10 particle size. By way of example, if the d10 particle size is 0.03 mm, then the d99 particle size can be 0.75 to 1.2 mm; or at 30 times greater, the d99 particle size would be 0.9 mm. Having a d99 particle size that is 25 to 40 times greater than the d10 particle size can provide superior fluid loss control over other particle size distributions wherein the d99 particle size is only 4 to 17 times greater than the d10 particle size. It is believed that this multiplier (e.g., 25, 30 or 35 times greater) allows the plurality of particles to have superior bridging efficiencies, packing capabilities, and provides improved fluid loss control, for example by aiding in developing a filter cake via the smallest particles.

The particle size distribution of the plurality of particles of the lost-circulation material can be selected such that the lost-circulation material provides a targeted fluid loss control. According to any of the embodiments, the particle size distribution of the plurality of particles of the LCM is selected such that the plurality of particles plugs permeable areas of the subterranean formation, for example having a largest dimension ranging from 10 to 190 microns. The concentration of the plurality of particles of the LCM can also be selected such that the plurality of particles plugs permeable areas of the subterranean formation, for example having a largest dimension ranging from 10 to 190 microns. By way of example, the concentration of the LCM may need to be increased for permeable areas having a largest dimension of 190 microns compared to ones having a largest dimension of 50 microns.

The PSD of the LCM can be selected such that the targeted fluid loss control is achieved. By way of example, the targeted fluid loss control can be at least 70%, 80%, or 90% by volume of the base fluid is not lost through permeable areas of the subterranean formation. According to another embodiment, the PSD is selected such that the treatment fluid has a scaling pressure of at least 30 psi (0.2 MPa). The PSD can also be selected such that the treatment fluid has a scaling pressure of at least 100 psi (0.7 MPa). The PSD can also be selected such that the treatment fluid has a sealing pressure in the range of about 30 to about 100 psi (about 0.2 to about 0.7 MPa), alternatively about 50 to about 80 psi (about 0.3 to about 0.6 MPa). According to another embodiment, the PSD is selected such that the treatment fluid has the stated scaling pressure at the bottomhole pressure of the well. As used herein, the term “bottomhole” means the portion of the well to be treated.

As discussed above, the inorganic plurality of particles of the LCM can be solid aggregates of minerals. Different minerals are made up of different elements. Some of the minerals can contain calcium, aluminum, and magnesium compounds. The specific mineral or the specific mixture of different minerals can be selected to impart desirable properties to the treatment fluid. By way of example, for a cement composition, it may be desirable to have increased compressive strength or longer-term zonal isolation, which is before the set cement composition degrades such that zonal isolation is no longer achieved. It is believed that some of the compounds (e.g., calcium, aluminum, or magnesium) can chemically react with hydration products (e.g., calcium silicate hydrate “CSH” and calcium hydroxide) of the cement slurry to yield improved properties. Without being limited by theory, it is believed that this unique physiochemistry reaction may include surface-to-surface attraction of particles due to their reaction with the high pH of cement or specific polymers used in the treatment fluid. Quartz, for example, can react with calcium hydroxide in hydrated cement, which improves the compressive strength of the cement through the formation of calcium silicate hydrate. Other minerals besides quartz that contains silica or silicon dioxide can also improve the compressive strength. When the treatment fluid is a spacer fluid, the mineral particles can already be packed into permeable areas of the subterranean formation. Thus, when a cement composition is introduced into the wellbore, it allows the chemical reaction of the mineral particles and the cement in the annulus, which improves the sealing capabilities of the LCM.

The plurality of particles of the LCM includes a plurality of particle size ranges (i.e., the PSD of d90, d50, d10, etc.). The plurality of particles for a specific particle size range (e.g., the particle size range for d50) can include a combination of different minerals. The concentration of the different minerals in the combination can vary. Table 2 illustrates just one example of how the minerology concentrations, which are expressed as a percentage of the whole, can be different depending on the US sieve size. The mesh size is the number of openings per linear square inch in a screen.

TABLE 2

| US Sieve | Mesh | Opening size | Cal- | Dolo- | | |
|---|---|---|---|---|---|---|
| Size | Size | (mm) | cite | mite | Quartz | Feldspar |
| >=20 | 20 | 0.841 | 28 | 12 | 18 | 25 |
| <20-40 | 20-35 | 0.840-0.420 | 21 | 10 | 16 | 22 |
| <40-70 | 35-65 | 0.419-0.210 | 29 | 8 | 28 | 12 |
| <70-100 | 65-100 | 0.209-0.149 | 36 | 15 | 38 | 8 |
| <100-140 | 100-150 | 0.148-0.105 | 47 | 25 | 24 | 3 |
| <140-270 | 150-270 | 0.104-0.053 | 55 | 24 | 6 | 1 |
| <270-325 | 270-325 | 0.052-0.044 | 53 | 27 | 2 | ′— |
| >325 | 325 | 0.045+ | 54 | 32 | 2 | ′— |

The plurality of particle size ranges can be selected to provide a targeted minerology of the combination. Optimizing the targeted minerology of the combination can be selected based on the specific treatment fluid used (e.g., a drilling fluid versus a cement composition), the subterranean formation conditions, and desired chemical interaction with other ingredients in the treatment fluid (e.g., to react with hydration products of a cement slurry to improve the properties of the set cement). By way of example if a higher concentration of quartz is desired, then a US sieve size of 70-100 can be selected that provides 38% quartz in the mineral combination. By contrast, if a higher concentration of calcite is desired, then a US sieve size of 140-270 can be selected. The exact combination can then be tailored to fit the targeted particle size distribution as well as the targeted minerology of the plurality of particles.

According to an embodiment, the LCM is in a concentration of at least 0.1 pounds per barrel (“ppb”) of the treatment fluid (0.4 kilograms per cubic meter “kg/m³”). The LCM can be in a concentration in the range of 0.1 to 300 ppb (0.4 to 1,159.6 kg/m³), alternatively 0.5 to 200 ppb (1.9 to 773 kg/m³) of the treatment fluid. The LCM concentration can be selected such that a targeted fluid loss control is achieved. By way of example, the targeted fluid loss control can be at least 70%, 80%, or 90% by volume of the base fluid is not lost through permeable areas of the subterranean formation. According to another embodiment, the concentration of the LCM is selected such that the treatment fluid has a sealing pressure of at least 30 psi (0.2 MPa). The concentration of the LCM can also be selected such that the treatment fluid has a scaling pressure of at least 100 psi (0.7 MPa). The concentration of the LCM can also be selected such that the treatment fluid has a sealing pressure in the range of about 30 to about 100 psi (about 0.2 to about 0.7 MPa), alternatively about 50 to about 80 psi (about 0.3 to about 0.6 MPa). According to another embodiment, the concentration of the LCM is selected such that the treatment fluid has a sealing pressure at the bottomhole pressure of the well.

The LCM can have a specific gravity in the range from 1.1 to 1.59, alternatively 1.6 to 2.1, alternatively from 1.75 to 2. Preferably, the LCM has a specific gravity in the range from 1.85 to 1.9.

The treatment fluid can have a sealing pressure of at least 20 psi (0.1 MPa), alternatively at least 40 psi (0.3 MPa), alternatively at least 100 psi (0.7 MPa). Preferably, the treatment fluid has the sealing pressure at the bottomhole pressure of the well. The treatment fluid can have a sealing time of less than 10 minutes (min.), alternatively less than 5 min., alternatively less than 3 min.

If the treatment fluid is a cement composition, then the treatment fluid can develop a compressive strength of at least 1,000 psi (6.9 MPa) at a temperature of 100° F. (37.8° C.). The cement composition treatment fluid can also develop a compressive strength of at least 1,200 psi (8.3 MPa), preferably at least 1,400 psi (9.7 MPa) at a temperature of 100° F. (37.8° C.). According to another embodiment, if the treatment fluid is a cement composition, then the treatment fluid develops a compressive strength of at least 2,500 psi (17.2 MPa) at a temperature of 190° F. (87.8° C.). The cement composition treatment fluid can also develop a compressive strength of at least 2,800 psi (19.3 MPa), preferably at least 3,100 psi (21.4 MPa) at a temperature of 190° F. (87.8° C.). The cement composition treatment fluid can also develop a compressive strength of at least 1,200 psi (8.3 MPa), preferably at least 2,500 psi (17.2 MPa) at the bottomhole temperature of the well.

The method embodiments include the step of introducing the treatment fluid into a subterranean formation. The step of introducing can be for the purposes of drilling a wellbore that penetrates the subterranean formation. The well can have a bottomhole temperature in the range of about 35° F. to about 800° F. (about 1.7° C. to about 426.7° C.). The step of introducing can be for the purpose of at least one of the following: drilling operations; well completion; well conditioning; foam cementing; primary or secondary cementing operations; well-plugging; squeeze cementing; gravel packing; hydraulic fracturing. If the treatment fluid is a cement composition, then the cement composition can be in a pumpable state before and during introduction into the wellbore. The well can be, without limitation, an oil, gas, water, or injection well. The well can include an annulus. The step of introducing can include introducing the cement composition into a portion of the annulus.

If the treatment fluid is a cement composition, then the cement composition can be allowed to set after introduction into a wellbore. Perforating, fracturing, or performing an acidizing treatment can occur after the cement composition has set.

If the treatment fluid is a cement composition, then the treatment fluid can further include cement. The cement can be Class A cement, Class C cement, Class G cement, Class H cement, fly ash, slag, volcanic ash, pozzolans, and any combination thereof.

The treatment fluid can further include an additive. Examples of an additive include, but are not limited to, a filler, a fluid loss additive, a set retarder, a friction reducer, a strength-retrogression additive, a defoaming agent, a high-density additive, a set accelerator, a mechanical property enhancing additive, a filtration-control additive, a thixotropic additive, nano-particles, and combinations thereof.

The treatment fluid can have a density of at least 8 pounds per gallon (ppg) (0.96 kilograms per liter (kg/l)). The treatment fluid can also have a density in a range of 8 to 20 ppg (0.96 to 2.40 kg/l).

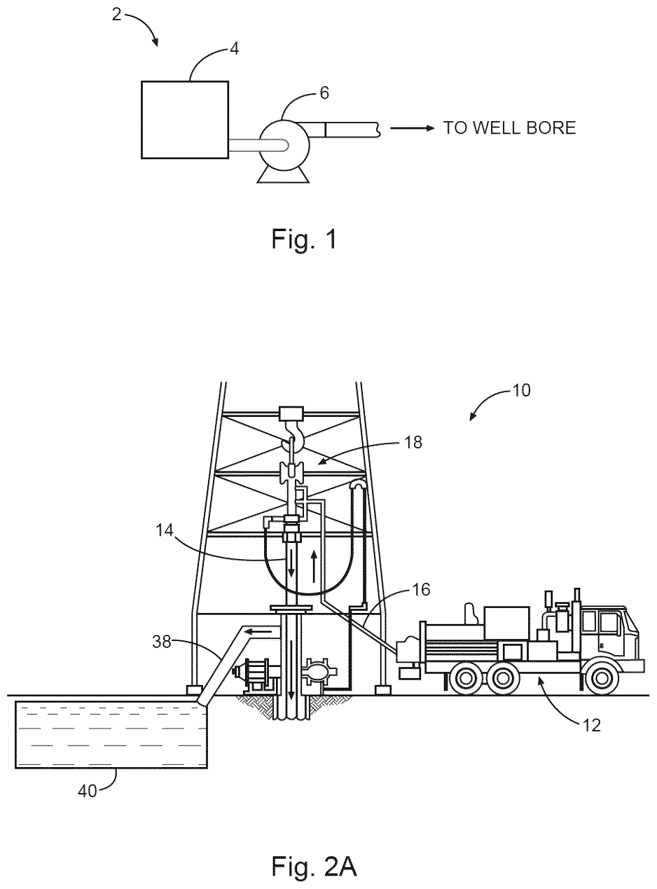

FIG. 1 illustrates a system that can be used in the preparation of a cement composition and delivery to a wellbore according to any of the embodiments. As shown, the cement composition can be mixed in mixing equipment 4, such as a jet mixer, re-circulating mixer, or a batch mixer, for example, and then pumped via pumping equipment 6 to the wellbore. The mixing equipment 4 and the pumping equipment 6 can be located on one or more cement trucks. A jet mixer can be used, for example, to continuously mix the cement composition, including water, as it is being pumped to the wellbore.

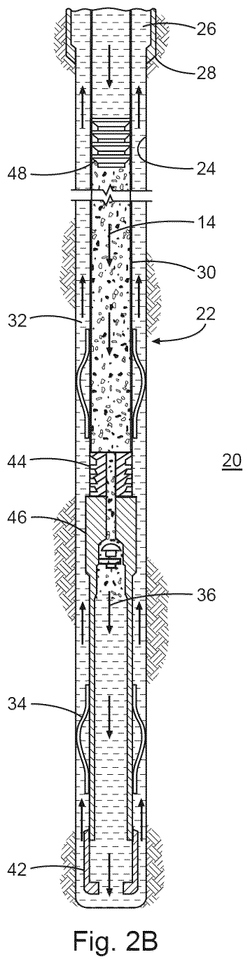

An example technique and system for introducing the cement composition into a subterranean formation will now be described with reference to FIGS. 2A and 2B. FIG. 2A illustrates surface equipment 10 that can be used to introduce the cement composition. It should be noted that while FIG. 2A generally depicts a land-based operation, those skilled in the art will readily recognize that the principles described herein are equally applicable to subsea operations that employ floating or sea-based platforms and rigs, without departing from the scope of the disclosure. The surface equipment 10 can include a cementing unit 12, which can include one or more cement trucks, mixing equipment 4, and pumping equipment 6 (e.g., as depicted in FIG. 1). The cementing unit 12 can pump the cement composition 14 through a feed pipe 16 and to a cementing head 18, which conveys the cement composition 14 downhole.

The methods can include the step of introducing the cement composition into the subterranean formation 20. Turning now to FIG. 2B, the cement composition 14 can be introduced into a subterranean formation 20. The step of introducing can include pumping the cement composition into the subterranean formation using one or more pumps 6. The step of introducing can be for the purpose of at least one of the following: well completion; foam cementing; primary or secondary cementing operations; well-plugging; squeeze cementing; and gravel packing. The cement composition can be in a pumpable state before and during introduction into the subterranean formation 20. The subterranean formation 20 is penetrated by a well 22. The well can be, without limitation, an oil, gas, or water production well, an injection well, a geothermal well, or a high-temperature and high-pressure (HTHP) well. The step of introducing can include introducing the cement composition into the well 22. The wellbore 22 comprises walls 24. A surface casing 26 can be inserted into the wellbore 22. The surface casing 26 can be cemented to the walls 24 via a cement sheath 28. One or more additional conduits (e.g., intermediate casing, production casing, liners, etc.) shown here as casing 30 can also be disposed in the wellbore 22. One or more centralizers 34 can be attached to the casing 30, for example, to centralize the casing 30 in the wellbore 22 prior to and during the cementing operation. According to another embodiment, the subterranean formation 20 is penetrated by a wellbore 22 and the well includes an annulus 32 formed between the casing 30 and the walls 24 of the wellbore 22 and/or the surface casing 26. According to this other embodiment, the step of introducing includes introducing the cement composition into a portion of the annulus 32.

With continued reference to FIG. 2B, the cement composition 14 can be pumped down the interior of the casing 30. The cement composition 14 can be allowed to flow down the interior of the casing 30 through the casing shoe 42 at the bottom of the casing 30 and up around the casing 30 into the annulus 32. While not illustrated, other techniques can also be utilized for introduction of the cement composition 14. By way of example, reverse circulation techniques can be used that include introducing the cement composition 14 into the subterranean formation 20 by way of the annulus 32 instead of through the casing 30.

As it is introduced, the cement composition 14 may displace other fluids 36, such as drilling fluids and/or spacer fluids that may be present in the interior of the casing 30 and/or the annulus 32. At least a portion of the displaced fluids 36 can exit the annulus 32 via a flow line 38 and be deposited, for example, in one or more retention pits 40 (e.g., a mud pit), as shown on FIG. 2A. Referring again to FIG. 2B, a bottom plug 44 can be introduced into the wellbore 22 ahead of the cement composition 14, for example, to separate the cement composition 14 from the fluids 36 that may be inside the casing 30 prior to cementing. After the bottom plug 44 reaches the landing collar 46, a diaphragm or other suitable device ruptures to allow the cement composition 14 through the bottom plug 44. In FIG. 2B, the bottom plug 44 is shown on the landing collar 46. In the illustrated embodiment, a top plug 48 can be introduced into the wellbore 22 behind the cement composition 14. The top plug 48 can separate the cement composition 14 from a displacement fluid 50 and also push the cement composition 14 through the bottom plug 44.

An embodiment of the present disclosure is a treatment fluid comprising: a base fluid; and a lost-circulation material, wherein the lost-circulation material comprises a plurality of particles of inorganic components of roofing materials, wherein the plurality of particles has a particle size distribution, and wherein the d99 particle size is in a range of 25 to 40 times greater than the d10 particle size. Optionally, the treatment fluid is a drilling fluid, a spacer fluid, a cement composition, or a stimulation fluid. Optionally, the roofing materials are recycled roofing materials. Optionally, the lost-circulation material comprises organic components of roofing materials at a concentration in a range of 0 to 10 weight percent of the roofing materials. Optionally, the plurality of particles is solid aggregates of a mineral. Optionally, the mineral is selected from the group consisting of calcite, dolomite, quartz, feldspar, mica, chlorite, and any combination in any proportion thereof. Optionally, the plurality of particles has a plurality of particle size ranges, and wherein the plurality of particles for a specific particle size range comprises a combination of different minerals. Optionally, the plurality of particle size ranges is selected to provide a targeted minerology of the combination. Optionally, the plurality of particles has a particle size distribution of d99 in a range of 0.8 to 1.8 mm, d90 in a range of 0.50 to 0.75 mm, d50 in a range of 0.15 to 0.35 mm, and d10 in a range of 0.02 to 0.05 mm. Optionally, the d99 particle size is 30 times greater than the d10 particle size. Optionally, the treatment fluid provides a targeted fluid loss control. Optionally, the targeted fluid loss control is at least 70% by volume of the base fluid is not lost through permeable areas of a subterranean formation. Optionally, the particle size distribution is selected such that the treatment fluid provides the targeted fluid loss control. Optionally, the treatment fluid has a sealing pressure of at least 30 psi (0.2 MPa). Optionally, the lost-circulation material is in a concentration in a range of 0.1 to 300 ppb (0.4 to 1,160 kg/m³). Optionally, the lost-circulation material has a specific gravity in a range from 1.1 to 2.1.

Another embodiment of the present disclosure is a method of treating a portion of a subterranean formation comprising: introducing a treatment fluid into the portion of the subterranean formation, the treatment fluid comprising: a base fluid; and a lost-circulation material, wherein the lost-circulation material comprises a plurality of particles of inorganic components of roofing materials, wherein the plurality of particles has a particle size distribution, and wherein the d99 particle size is in a range of 25 to 40 times greater than the d10 particle size; and allowing the lost-circulation material to reduce loss of the base fluid into the subterranean formation. Optionally, the treatment fluid is a drilling fluid, a spacer fluid, a cement composition, or a stimulation fluid. Optionally, the roofing materials are recycled roofing materials. Optionally, the lost-circulation material comprises organic components of roofing materials at a concentration in a range of 0 to 10 weight percent of the roofing materials. Optionally, the plurality of particles is solid aggregates of a mineral. Optionally, the mineral is selected from the group consisting of calcite, dolomite, quartz, feldspar, mica, chlorite, and any combination in any proportion thereof. Optionally, the plurality of particles has a plurality of particle size ranges, and wherein the plurality of particles for a specific particle size range comprises a combination of different minerals. Optionally, the plurality of particle size ranges is selected to provide a targeted minerology of the combination. Optionally, the plurality of particles has a particle size distribution of d99 in a range of 0.8 to 1.8 mm, d90 in a range of 0.50 to 0.75 mm, d50 in a range of 0.15 to 0.35 mm, and d10 in a range of 0.02 to 0.05 mm. Optionally, the d99 particle size is 30 times greater than the d10 particle size. Optionally, the treatment fluid provides a targeted fluid loss control. Optionally, the targeted fluid loss control is at least 70% by volume of the base fluid is not lost through permeable areas of a subterranean formation. Optionally, the particle size distribution is selected such that the treatment fluid provides the targeted fluid loss control. Optionally, the treatment fluid has a sealing pressure of at least 30 psi (0.2 MPa). Optionally, the lost-circulation material is in a concentration in a range of 0.1 to 300 ppb (0.4 to 1,160 kg/m³). Optionally, the lost-circulation material has a specific gravity in a range from 1.1 to 2.1.

Therefore, the various embodiments are well adapted to attain the ends and advantages mentioned as well as those that are inherent therein. The particular embodiments disclosed above are illustrative only, as the various embodiments may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention.

As used herein, the words “comprise,” “have,” “include,” and all grammatical variations thereof are each intended to have an open, non-limiting meaning that does not exclude additional elements or steps. While compositions, systems, and methods are described in terms of “comprising,” “containing,” or “including” various components or steps, the compositions, systems, and methods also can “consist essentially of” or “consist of” the various components and steps. It should also be understood that, as used herein, “first,” “second,” and “third,” are assigned arbitrarily and are merely intended to differentiate between two or more fluids, sizes, etc., as the case may be, and does not indicate any sequence. Furthermore, it is to be understood that the mere use of the word “first” does not require that there be any “second,” and the mere use of the word “second” does not require that there be any “third,” etc.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent(s) or other documents that may be incorporated herein by reference, the definitions that are consistent with this specification should be adopted.

What is claimed is:

1. A treatment fluid comprising:
a base fluid; and
a lost-circulation material, wherein the lost-circulation material comprises a plurality of particles of inorganic components of roofing materials,
wherein the plurality of particles has a particle size distribution, and wherein the d99 particle size is in a range of 25 to 40 times greater than the d10 particle size.

2. The treatment fluid according to claim 1, wherein the treatment fluid is a drilling fluid, a spacer fluid, a cement composition, or a stimulation fluid.

3. The treatment fluid according to claim 1, wherein the roofing materials are recycled roofing materials.

4. The treatment fluid according to claim 1, wherein the lost-circulation material comprises organic components of roofing materials at a concentration in a range of 0 to 10 weight percent of the roofing materials.

5. The treatment fluid according to claim 1, wherein the plurality of particles is solid aggregates of a mineral.

6. The treatment fluid according to claim 5, wherein the mineral is selected from the group consisting of calcite, dolomite, quartz, feldspar, mica, chlorite, and any combination in any proportion thereof.

7. The treatment fluid according to claim 6, wherein the plurality of particles has a plurality of particle size ranges, and wherein the plurality of particles for a specific particle size range comprises a combination of different minerals.

8. The treatment fluid according to claim 7, wherein the plurality of particle size ranges is selected to provide a targeted minerology of the combination.

9. The treatment fluid according to claim 1, wherein the plurality of particles has a particle size distribution of d99 in a range of 0.8 to 1.8 mm, d90 in a range of 0.50 to 0.75 mm, d50 in a range of 0.15 to 0.35 mm, and d10 in a range of 0.02 to 0.05 mm.

10. The treatment fluid according to claim 1, wherein the d99 particle size is 30 times greater than the d10 particle size.

11. The treatment fluid according to claim 1, wherein the treatment fluid provides a targeted fluid loss control.

12. The treatment fluid according to claim 11, wherein the targeted fluid loss control is at least 70% by volume of the base fluid is not lost through permeable areas of a subterranean formation.

13. The treatment fluid according to claim 12, wherein the particle size distribution is selected such that the treatment fluid provides the targeted fluid loss control.

14. The treatment fluid according to claim 1, wherein the treatment fluid has a sealing pressure of at least 30 psi (0.2 MPa).

15. The treatment fluid according to claim 1, wherein the lost-circulation material is in a concentration in a range of 0.1 to 300 ppb (0.4 to 1,160 kg/m³).

16. The treatment fluid according to claim 1, wherein the lost-circulation material has a specific gravity in a range from 1.1 to 2.1.

17. A method of treating a portion of a subterranean formation comprising:
introducing a treatment fluid into the portion of the subterranean formation, the treatment fluid comprising:
a base fluid; and
a lost-circulation material, wherein the lost-circulation material comprises a plurality of particles of inorganic components of roofing materials,
wherein the plurality of particles has a particle size distribution, and wherein the d99 particle size is in a range of 25 to 40 times greater than the d10 particle size; and
allowing the lost-circulation material to reduce loss of the base fluid into the subterranean formation.

18. The method according to claim 17, wherein the treatment fluid is a drilling fluid, a spacer fluid, a cement composition, or a stimulation fluid.

19. The method according to claim 17, wherein the plurality of particles is solid aggregates of a mineral, and wherein the mineral is selected from the group consisting of calcite, dolomite, quartz, feldspar, mica, chlorite, and any combination in any proportion thereof.

20. The method according to claim 17, wherein the plurality of particles has a particle size distribution of d99 in a range of 0.8 to 1.8 mm, d90 in a range of 0.50 to 0.75 mm, d50 in a range of 0.15 to 0.35 mm, and d10 in a range of 0.02 to 0.05 mm.
